(19) United States
(12) Patent Application Publication
(10) Pub. No.: US 2016/0127435 A1
(43) Pub. Date: May 5, 2016

(54) Method for Delivering Advertising Content and/or Advertising Media and Communication System for Performing the Method

(71) Applicant: ProSiebenSat. 1 Digital GmbH, Unterfohring (DE)

(72) Inventors: Marc Gritsch, Munchen (DE); Horst Bartsch, Berlin (DE)

(21) Appl. No.: 14/926,285

(22) Filed: Oct. 29, 2015

(30) Foreign Application Priority Data
Oct. 30, 2014 (DE) 10 2014 016 137.4

(51) Int. Cl. H04L 29/06; G06Q 30/02; H04L 29/08

(52) U.S. Cl. CPC H04L 65/4084; H04L 67/02; H04L 65/105; G06Q 30/0277

(57) ABSTRACT

The invention relates to a method for delivering advertising content and/or advertising media from an advertising media server to a client device, wherein the client device transmits a request for advertising content and/or advertising media to a Flash socket server via an initiated Flash socket connection, the Flash socket server communicates with the advertising media server addressed in the request to initiate a transmission of the advertising content and/or advertising media requested by the client device, and wherein the transmission of the requested advertising content and/or advertising media from the advertising media server to the client device takes place via the Flash socket server and the Flash socket connection set up between the Flash socket server and the client device and/or the transmission of the advertising content and/or advertising media takes place to at least one third server from which the advertising media and/or advertising content can be retrieved by the client device.

### BACKGROUND OF THE INVENTION

The invention relates to a method for delivering advertising content and/or advertising media from an advertising media server to a client device. The invention moreover comprises a communication system for carrying out such a method.

A large part of the information content published via the internet is free and is financed by the operator by advertising revenue. For this purpose, advertising content and/or advertising media are shown on the website of the operator to draw the user's attention to them. In addition to showing static image material which is simply embedded in the HTML code of the website to be displayed, the introduction of whole advertising films during video playback is gaining more and more importance. The user in this respect starts the desired video content, with an advertising film being displayed to him before, during or at the end of the video content. The playing of the video content and the advertising material as a rule takes place via the same player software on the user's end device.

As a rule, it is sensible to tailor the advertising content to target groups since the user will only take note of and accept the showing of advertising content of interest to him. This procedure is also called “targeting” in technical jargon. Special advertising media servers are used for the delivery of tailored advertising content to the respective visitor which search for advertising media or advertising content matching every single user from the advertising database and deliver it to the user's end device. As a rule, the client device receives instructions together with a target address of an advertising media server on accessing an information server. The client device thereupon automatically contacts the linked advertising media server and retrieves the available advertising media or advertising content. When surfing on a website, the user's web browser automatically communicates with the advertising media server.

There is a need from the viewpoint of the website operator to carry out such advertising deliveries as completely and as free of error as possible in order to be able to earn sufficient revenue from the free offering. Currently some software programs are available on the market for installation on the user's end device which monitor outgoing advertising requests and block them as required, whereby the showing of any advertising media and advertising content is suppressed. These software tools, also called ad blockers, check outgoing connection attempts of the client device as to whether they are directed to a known advertising media server. Filter lists are used for this purpose which contain target addresses of advertising media servers. If an outgoing connection establishment is directed to a known target address of an advertising media server, this is actively prevented by the installed software tool and the retrieval of advertising media or of advertising content is thereby suppressed. Keywords such as “advertising” or “ad” within the address can also already be sufficient for recognizing an outgoing connection to a web server.

### SUMMARY OF THE INVENTION

The present invention therefore has the object of showing possibilities of ensuring an error-free delivery of advertising media or advertising content despite any correspondingly installed software.

This object is achieved on the one hand by a method in accordance with the features herein. Advantageous embodiments of the method are the subject of the invention herein.

In accordance with the invention, a method is proposed for delivering advertising content and/or advertising media from an advertising media server to a client device, wherein, in a first step, the client device transmits a request for advertising content and/or advertising media to a Flash socket server via an initiated Flash socket connection. A corresponding request is triggered, for example, in that the client device would like to retrieve information from an information server in a user-controlled process. In such a case, the client device is preferably instructed by information provided by the information server to transmit a request for advertising content or advertising media to the Flash socket server via a Flash socket connection especially established for this purpose.

A Flash socket connection is understood as a socket connection which is opened by a Flash application or a Flash plug-in/Flash module. A Flash video player counts as a Flash application, for example. A server, for example a web server, is used as the Flash socket server which is suitable for establishing a corresponding Flash socket connection with the client device.

Provision is made in a further method step that the Flash socket server communicates with the advertising media server addressed in the request to initiate a transmission of the advertising content and/or advertising media requested by the client device. On the side of the Flash socket server, this communication can comprise forwarding the received request of the client device to the advertising media server. The Flash socket server can, however, likewise revise the request and forward a modified request.

Provision can be made in accordance with a first option of the invention that the transmission of the requested advertising content and/or advertising media from the advertising media server to the client device takes place via the interposed Flash socket server and the Flash socket connection established between the Flash socket server and the client device.

Installed ad blockers typically check specific connection types and block them. These software programs can, however, no longer recognize outgoing requests and the outgoing advertising delivery can be ensured by the use of a Flash socket connection between the client device and a Flash socket server.

The initially presented ad blockers are typically provided as plug-ins for the user's browser software. The use of a Flash socket connection for requesting advertising media or advertising content additionally has the advantage that this request is no longer initiated by the browser software, but instead by another application, for example a Flash player, running on the client device. Ad blockers in the form of plug-ins for web browsers only have access to the routines of the web browser, that is they can only check outgoing connection attempts of the browser application itself. The plug-ins do not have any access or any possibilities of monitoring applications running in parallel.

Provision can furthermore be made that, additionally or alternatively, the transmission of the advertising content and/or advertising media to the client device does not take place via the Flash socket server, but the advertising media/advertising content are rather transmitted indirectly or directly by the advertising media server to at least one third party server from which the advertising media and/or advertising content can be retrieved by the client device. This procedure is in particular practical when the target addresses of outgoing connections of the client device are filtered with respect to addresses of known advertising media servers. Since the requested advertising media and/or advertising content are/is transmitted from the actual advertising media server to a third party server, the retrieval address for advertising media/advertising content changes for the client device. An address filtering of an active ad blocker is thus skillfully made impossible.

It is particularly preferred if a Flash application, in particular a Flash player, executed on the client device initiates the connection to the Flash socket server.

The Flash socket server itself can comprise its own hardware architecture or can optionally be installed as an additional software module on the actual advertising media server. Any hardware structure is conceivable which is suitable for executing a Flash socket server to respond to and further process corresponding requests of a client device.

In a particularly preferred embodiment of the invention, an authentication process is initiated prior to the establishing of the Flash socket connection by the client device, in particular the Flash player, to make possible an authentication of the requesting Flash module—also called a cross-domain check. A check is first thereby made as to whether the required authorization of the client device to establish a Flash socket connection to the Flash socket server is present. The Flash socket server is protected against attacks from the public internet by this measure since only those requests for possible socket connections are processed which are authorized to do so on the basis of a verification file.

A Flash socket connection is preferably based on a TCP socket. It is conceivable that only the connection between the client device and the Flash socket server is based on a Flash socket connection. The remaining communication between the Flash socket server and the advertising media server or other components can take place without a socket connection; however, there is no reason against such a socket connection.

Provision is made in a particularly advantageous embodiment variant of the method in accordance with the invention that a transmission of the advertising media or advertising content initiated by the Flash socket server has the result that said advertising media or advertising content are transmitted from the advertising media server to a third party server, with the third party server corresponding to the original information server or web server from which the client device wants to retrieve the desired information in a user-controlled process. The transmission from the advertising media server to the third party server as the information server can take place either directly or indirectly, for example via the Flash socket server or via a further interposed server as a temporary storage space.

If the third party server corresponds to the information server/web server, information content and advertising content/advertising media to be delivered are on identical servers with the same target address. An active ad blocker could admittedly also suppress attempts to connect to the information server/web server, but in this case information desired from the user side could also no longer be retrieved, which is presumably unacceptable from the viewpoint of the user and would presumably result in the deactivation of the blocking software.

The requested advertising media and/or advertising content are/is preferably transmitted from the advertising media server to the Flash server by progressive download processes, while the transmission from the Flash socket server to the information server takes place by an FTP protocol, ideally via an encoded FTP connection.

It is advantageous to avoid unnecessary data traffic in the communication system for the Flash socket server first to check on an incoming request of a client device whether the requested advertising content and/or advertising media is/are already available on the third party server or on the Flash socket server so that a repeated data transmission can be avoided. In this case, a transmission to the third party server or to the Flash socket server from the advertising media server is only initiated if the requested advertising content and/or advertising media are/is not yet available.

It is likewise conceivable first to check the target address of an advertising media server contained in the request of the client device against a whitelist and/or blacklist prior to the further process execution in the Flash socket sever or in the client device itself, with such lists containing either validated advertising media servers and/or blocked advertising media servers. Dubious requests for advertising media and/or advertising content can thereby be recognized and optionally blocked at the discretion of the operator of the information offering in order not to discredit it unnecessarily due to dubious advertising providers.

Additionally or alternatively to the blacklist or whitelist, provision can be made that the Flash socket server requires an authentication token for every incoming request to prevent DDOS attacks and only to support permitted clients. It is likewise conceivable that the initial advertising media request of a client is authenticated using the blacklist/whitelist, while all the subsequent requests of the client are secured by means of appended authentication tokens.

Provision can be made in response to a request of the client device for advertising content and/or advertising media that the client device conversely receives an information file via the Flash socket connection. This information file contains at least one target address for retrieving the requested advertising content and/or advertising media. The information file is as a rule generated by the advertising media server in response to a received request and is forwarded to the client device via the Flash socket server.

The target address for retrieving the advertising media contained in the information file corresponds to the address of the Flash socket server and/or to the address of a third party server to which the requested advertising content and/or advertising media has/have been transmitted.

In the already known process for delivering advertising content and/or advertising media, the client device makes a corresponding request to the advertising media server, the request being responded to by a matching information file of the advertising media server, with the client device then being advised which advertising content or which advertising media can be retrieved from the database of the advertising media server. It is conceivable against this background that a corresponding request of the client device to the Flash socket server is forwarded, optionally modified, to the advertising media server, whereupon the advertising media server generates the matching information file and then transmits it to the Flash socket server. It is expedient in this case for the Flash socket server to replace the target address included therein for retrieving the requested advertising media and/or advertising content either by its own address or by the target address of the third party server.

Provision can optionally be made that the generated information file of the advertising media server comprises further information or target addresses which are related to the delivery of advertising content and/or advertising media. Since such information or target addresses could likewise be recognized by an installed ad blocker, they have to be separately protected. It has proven to be advantageous for these addresses to be replaced with suitable temporary target addresses and/or temporary parameters before the information file is transmitted from the Flash socket server to the client device. Corresponding target addresses can, for example, point to service servers which are responsible for the monitoring and analysis of the delivery of advertising content and/or advertising media. The key words in this connection are so-called targeting services or frequency capping mechanisms.

In a particularly preferred embodiment variant of the method in accordance with the invention, the advertising media and/or advertising content comprise(s) audio data or video data, in particular video data of an advertising film, particularly preferably linear video data which are suitable for a pre-roll, mid-roll, post-roll, sponsor pre-split or post-split presentation to the client device.

A further aspect of the invention relates to an alternative method for delivering advertising content and/or advertising media from an advertising media server to a client device in accordance with the following features. In comparison with the method supra, instead of a Flash socket server, a proxy server is interposed between the client device and the advertising media server which only differs from the Flash socket server in that the connection between the client device and the proxy server is not based on a socket connection. It is, however, not necessary in this case that the second option is selected for the last method step, according to which the advertising content and/or advertising media are/is transmitted to at least one third party server from which the advertising media and/or advertising content can be retrieved by the client device. The method is in particular characterized by the aforesaid features which relate to a transmission to the third party server. The third party server preferably corresponds to the information server, i.e. the web server or content server.

The advantages and properties of this method obviously correspond to those of the aforesaid method so that a repeat description will be dispensed with at this point.

In addition, the invention relates to a communication system having at least one client device, at least one Flash socket server or proxy server, at least one advertising media server and, optionally, at least one third party server, with the listed components being configured such that they are suitable for performing the method in accordance with the invention.

Finally, the invention relates to a proxy server or Flash socket server which has corresponding means for performing the method. Both the communication system and the proxy server or Flash socket server accordingly have the same features and properties as the method in accordance with the invention.

### BRIEF DESCRIPTION OF THE DRAWINGS

Further advantages and properties of the invention will be explained in more detail in the following with reference to an embodiment shown in the drawings. There are shown:

FIG. 1: an overview for showing the design of the communication system in accordance with the invention; and

FIG. 2: a flow chart for illustrating the communication in relation to the exchange of cookies.

### DESCRIPTION OF THE PREFERRED EMBODIMENTS

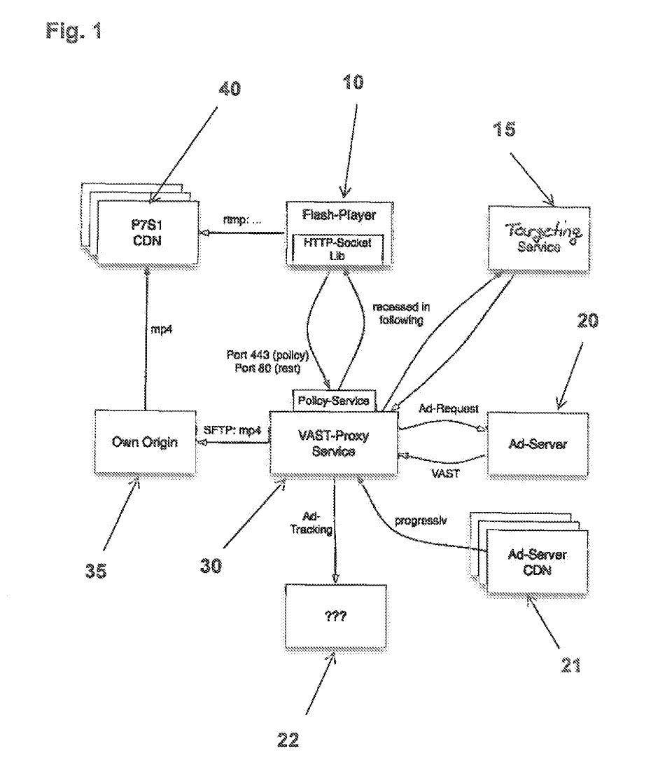

FIG. 1 shows a communication system for performing the method in accordance with the invention. The main components of the communication system are the client device 10, the advertising media server (ad server) 20 and the proxy server (VAST proxy service) 30 and the information server (P7S1 CDN) 40.

The client device can be a commercial PC, lap top or a mobile end device such as a smartphone or a tablet computer. A playing program for playing back Flash videos is installed on the client device. The playback program, called a Flash player in the following, can be configured as a plug-in for an installed web browser of the client device 10 or it can be installed and executable in the form of a separate program.

The advertising media server 20 comprises a logic which selects the advertising content and/or advertising media tailored to the individual user or user groups from the advertising media database 21 associated with the advertising media server in dependence on a received advertising media request. The database 21 can be a part of the advertising media server 20 or can be designed as a separate database server. The database 21 contains a number of pieces of advertising content, for example in the form of short advertising films or commercials or also other advertising media in the form of advertising banners and information related thereto.

In general, the client device 10 or the Flash application executed thereon can establish contact with the advertising media server 20 directly via the provided network connection. In accordance with the invention, however, in the embodiment shown, the proxy server 30 is interposed which processes the communication between the Flash player 10 and the advertising media server 20.

The starting situation will first be briefly looked at for the functionality of the communication system shown. The client device 10 or the user would like to retrieve information from a specific website of a network resource. This network resource is represented by the information server 40. In the specific embodiment, this information desired by the user includes audio information or video information which is present on the information server 40 in the form of a Flash file and is intended to be transmitted to the Flash player 10 for playing. The information server 40 can be a web server of the ProSiebenSat 1 corporate group on which specific video clips or whole TV episodes of the standard television programme are provided for retrieval. The provision of this video information is linked to advertising content to be able to finance the information offering, which is free as a rule. The advertising content and/or the advertising media can inter alia be played before, during or subsequently to the actual video clip; however, there are also alternative playing variants. The information server 40 can be an individual server or a server combination. The general term information server comprises in the embodiment shown a content delivery network (CDN) 40 which is a network of locally distributed servers connected over the internet with which content (in particular large media files) are delivered. The “own origin” server serves as the basis for the distribution over the CDN 40. The division between the CDN 40 and the “own origin” server 35 is in particular meaningful when the CDN is operated by a service provider and the information provider integrates the content to be disseminated in the CDN 40 through its own server 35 (“own origin” server).

As has already been explained above, installed ad blockers suppress outgoing connections of a web browser with an advertising media server. This can take place, for example, with reference to the initiated connection type or by means of filter lists, whereby the target address of outgoing connections is checked and, if the target address can be associated with a known advertising media server, this connection is suppressed by the ad blocker.

In accordance with the present invention, the establishment of the connection is no longer initiated by the web browser of the client device 10, but rather by the executed Flash player. Furthermore, it should not communicate directly with the advertising media server 20, but instead via a Flash socket connection with the interposed proxy server 30 which will also be called as VAST proxy service 30 in the following.

At the start, the client device retrieves the source code of the website from the information server 40 which is displayed by the browser of the client device 10. The video content offered on the website can be displaced using Flash player, with the Flash player typically being automatically accessed on the client device 10 by a script, in particular a JaveScript, integrated in the source code as soon as the user selects a video for display. The address of the VAST proxy server 30 and, where required, necessary instructions on the advertising retrieval, are simultaneously communicated to the Flash player of the client device 10 with this script, whereupon the client device 10, i.e. the Flash player, initiates a Flash socket connection with the Flash socket server 30. This connection is preferably made via port 80 of the client device.

Since advertising media requests are no longer executed by the web browser of the client device 10, but instead by the Flash player application, they can no longer be recognized and blocked by an ad blocker installed as a plug-in in the browser. A second point of the invention comprises the communication between the Flash player of the client device 10 and the VAST proxy service 30 being based on so-called Flash sockets. Flash sockets are based on a TCP connection which is made between the instance of the Flash player and a socket server executed on the VAST proxy service 30. In general, a separate instance, i.e. a separate Flash socket connection, can be initiated and utilized for every advertising media request. However, it may be meaningful to use a common Flash socket connection for at least a group of advertising media requests.

An upstream authentication procedure which checks the permissibility of a socket connection establishment between the client device 10 and the proxy service 30 is necessary for the initiation of a Flash socket between the two components. A policy request of the Flash player 10 to the VAST proxy service is first started via a suitable port and said VAST proxy service responds to the request by a transmission of the locally stored policy file to the client device 10 via port 80. Those port numbers are deemed suitable ports which are typically not blocked by relevant security mechanisms of the client 10 such as installed firewalls. If the authentication procedure is successful, a Flash socket can be established between the Flash player 10 and the socket server of the VAST proxy service 30. An authentication procedure is practically required for every instance.

The actual request for advertising content and/or advertising media (ad request) of the Flash player of the client device 10 is now not transmitted directly via this connection channel to the advertising media server 20, but instead to the VAST proxy service 30. The player initially checks, even before the sending of the request, whether a targeting cookie is present in the cookie store of the client device 10 for the purpose of targeting and frequency capping. This targeting cookie serves the profiling and estimating of the prospective product interests of the user and is generated by an external targeting server 15. The targeting cookie is furthermore likewise used for frequency capping to control the frequency with which a specific advert is shown to an individual client. Advertisers can deliver advertising and recommendations to presumed target groups on the basis of this targeting cookie.

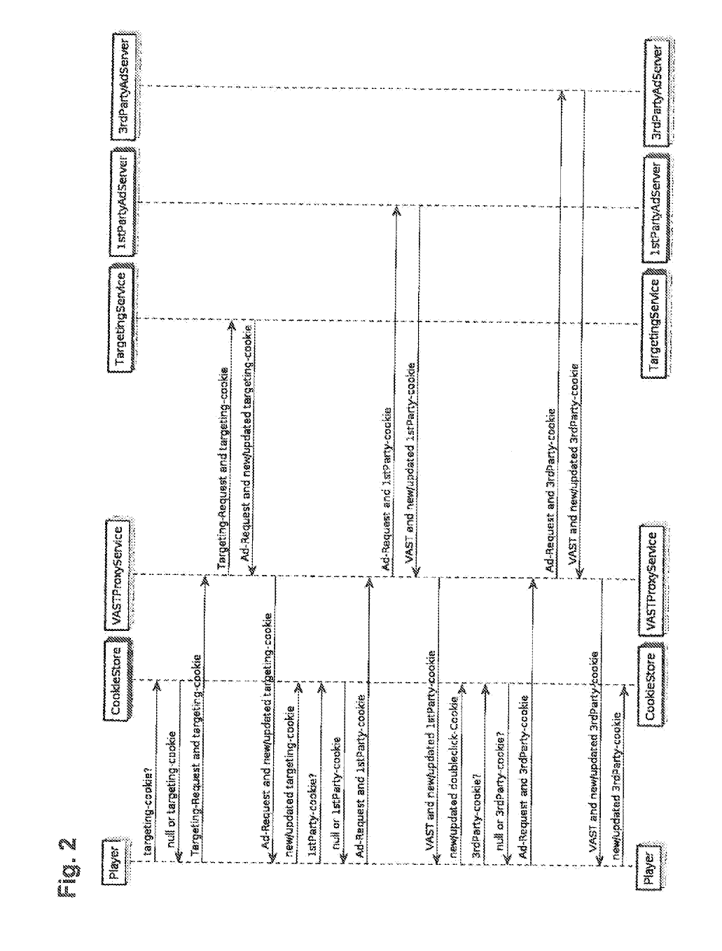

The player then sends, via the Flash socket connection, a targeting request to the VAST proxy server 30 and said request is then forwarded to the targeting service 15 by it. Provided that a targeting cookie is already present in the memory of the client device 10, it is sent to the targeting service 15 together with the targeting request for the purpose of updating. In response, the targeting service 15 updates the targeting cookie or creates a targeting cookie for the first time for the requesting client device 10. The targeting server 15 furthermore creates a request for advertising media and/or advertising content (ad request) tailored to the user of the client device 10 and forwards it to the client device 10 together with the updated targeting cookie via the VAST proxy service 30, with the transmission from the server 30 to the client device 10 via the Flash socket connection. The new or updated targeting cookie is stored in the cookie store of the client device 10. The routine can likewise be seen from the message diagram of FIG. 2.

After the updating procedure of the targeting cookie, the Flash player 10 sends the request for advertising media and/or advertising content together with associated cookies via the Flash socket connection to the VAST proxy service 30 which forwards the request (ad request) to the addressed advertising media server 20. The advertising media server 20 responds here with a corresponding information file, also called a VAST file, which contains information as to from which address the client device 10 can retrieve the requested advertising content and/or advertising media. The VAST file contains, in addition to the links to the advertising media, required information on the form in which the advertising should be displayed at which time on the client device 10. The VAST file furthermore also includes instructions for so-called tracking pixel requests which are to be executed by the client at exactly defined times, in particular play times of the advertising content/advertising media. Communication is initiated with the ad tracking system 22 for the tracking pixel requests. The requests of the client to be executed serve as proof of the delivery of the advertising content/advertising media.

There is the possibility that the first request for advertising media/advertising content is validated in the VAST proxy server 30, for example by a comparison of the addressed advertising media server 20 with a locally stored whitelist.

The target address within the VAST file, for example, points at a memory space of the database 21 connected to the advertising medium server 20. The VAST file of the advertising media server 20 received on the VAST proxy service 30 is, however, not immediately transmitted to the Flash player 10 via the socket connection, but is rather first evaluated and modified as required. In detail, the VAST proxy service 30 checks whether the requested advertising media and/or advertising content have/has already been requested earlier and are available for retrieval either on the VAST proxy service 30 or on the information server 40. If this is not the case, the VAST proxy service 30 initiates a progressive download of the advertising content and/or advertising media defined in the VAST file from the database 21 of the advertising media server 20. Subsequently, the files are transmitted from the VAST proxy service 30 via an FTP connection to the interposed server 35. An encoded FTP connection is preferably used, for example sFTP or FTPs. These files are then forwarded to the information server 40 by the interposed server 35.

In addition, the received VAST file of the advertising media server 20 is adapted in the VAST proxy service 30 such that the corresponding target address to the advertising content and/or advertising media is changed to the information server 40 by the database system 21.

It can additionally be conceivable that further information of the VAST file is changed, for instance the target addresses to a so-called ad tracking system 22 or also to a VAST wrapper address. The Flash player 10 is in this respect instructed by the VAST file to send information on the user behavior during the playing of advertising content and/or advertising media to the tracking system 22. For example, the Flash player 10 should report when the user accesses a hyperlink contained in the advertising media. The target address of the tracking system 22 is likewise forwarded to the tracking system 22 via the VAST proxy service 30. There are typically repeatedly transmissions to the tracking system 22 during the playing duration of individual advertising media/advertising content. To reduce the number of authentication procedures for Flash socket connections, it is meaningful only to execute them initially on the first request. The target addresses of the tracking system 22 contained in the VAST file are preferably extended by an authentication token in the VAST proxy server 30 to validate such connections for the future.

The modified VAST file is transmitted via the socket connection to the Flash player of the client device 10 which evaluates the VAST file and retrieves the requested advertising media and/or advertising content from the information server 40 by a RTMP connection. On receipt, the advertising content/advertising media are played back at the position of the actual video content predefined in the VAST file.

This procedure has the advantage that the target address of the advertising content and/or advertising media coincides with the address of the information server 40 and thus with the target address originally accessed by the user. An installed ad blocker can therefore no longer associate this target address to an advertising media server 20 and thereby suppress the transmission of the advertising content and/or advertising media from the information server 40 to the client device 10. Any connection could admittedly generally be blocked, but this would have the result that, in addition to the advertising content and/or advertising media, the information actually to be retrieved from the information server 40 would also be blocked. There is admittedly the possibility that an installed advertising blocker only blocks the specific paths to individual advertising media on the information server 40. This measure would, however, be easy to intercept since it is possible for the advertising provider without any great effort to rename the advertising media in the VAST proxy server every day.

The same advantage is achieved for the outgoing data transmission from the Flash player to the tracking system 22.

There is the possibility that the created VAST file of the advertising media server 30 does not contain any target address to advertising media and/or advertising content, but rather comprises at least one rerouting to a further advertising media server. This rerouting address (VAST wrapper address) would then likewise be replaced with the actual address by the VAST proxy service 30 and the VAST file would be forwarded to the Flash player. In response to the received VAST file, a further request for advertising media and/or advertising content would be transmitted by the Flash player to the VAST proxy service 30 via the Flash socket connection which then forwards it to the further advertising media server. The subsequent routine then corresponds to previously described method steps. This variant can be seen from the message diagram of FIG. 2.

1. A method for delivering advertising content and/or advertising media from an advertising media server to a client device, wherein
the client device transmits a request for advertising content and/or advertising media to a Flash socket server via an initiated Flash socket connection;
the Flash socket server communicates with the advertising media server addressed in the request to initiate a transmission of the advertising content and/or advertising media requested by the client device; and
the transmission of the requested advertising content and/or advertising media takes place from the advertising media server to the client device via the Flash socket server and the Flash socket connection established between the Flash socket server and the client device; and/or
the transmission of the advertising content and/or advertising media takes place to at least one third party server from which the advertising media and/or advertising content can be retrieved by the client device.

2. A method in accordance with claim 1, wherein a Flash application, in particular a Flash player, executed on the client device, initiates the connection to the Flash socket server.

3. A method in accordance with claim 1, wherein an authentication procedure is initiated before the establishing of the Flash socket connection by the client device, in particular the Flash player, to check the authorization of a Flash socket connection between the client device and the Flash socket server.

4. A method in accordance with claim 1, wherein the third party server corresponds to an information server, for example a web server, from which the client device has retrieved or would like to retrieve information in a user-controlled manner.

5. A method in accordance with claim 1, wherein the Flash socket server checks on an incoming request of a client device whether the requested advertising content and/or advertising media are already available on the third party server and only initiates a transmission if they are not yet available.

6. A method in accordance with claim 1, wherein the advertising content and/or advertising media are transmitted to the third party server via the Flash socket server, with a progressive download preferably being used for the data transmission to the Flash socket server and the transmission to the third party server preferably taking place by an FTP protocol.

7. A method in accordance with claim 1, wherein the target address of the advertising media server contained in the request of the client device is checked against a whitelist and/or a blacklist with validated and/or blocked advertising media servers.

8. A method in accordance with claim 1, wherein an information file is sent to the client device in response to the request for advertising content and/or advertising media by the Flash socket server over the Flash socket connection, the information file comprising at least one target address of the Flash socket server and/or third party server for retrieving the advertising content and/or advertising media.

9. A method in accordance with claim 8, wherein the information file is originally generated by the advertising media server in response to the request for advertising content and/or advertising media, with the Flash socket server replacing at least a target address included in the original information file with the target address of the Flash socket server and/or of the third party server.

10. A method in accordance with claim 9, wherein the information file includes one or more target addresses to one or more service servers, in particular service servers for the recording of one or more parameters relevant to the delivery of advertising content and/or advertising media, with all or at least some of these target addresses being replaced with temporary target addresses or with the target address of the Flash socket server and/or being extended by an authentication token.

11. A method in accordance with claim 1, wherein the advertising media and/or advertising content are video data, in particular video data of an advertising film, particularly preferably linear video data which are suitable for a pre-roll, mid-roll, post-roll, sponsor pre-split or post-split display at the client device.

12. A method for delivering advertising content and/or advertising media from an advertising media server to a client device, wherein
(a) the client device transmits a request for advertising content and/or advertising media to a proxy server;
(b) the proxy server communicates with the advertising media server to initiate a transmission of the advertising content and/or advertising media requested by the client device; and
(c) the advertising content and/or the advertising media are transmitted to at least one third party server from which the advertising media and/or advertising content can be retrieved by the client device.

13. A method in accordance with claim 12, wherein the third party server corresponds to an information server, for example a web server, from which the client device has retrieved or would like to retrieve information in a user-controlled manner.

14. A communication system having at least one client device, at least one Flash socket server or proxy server, at least one advertising media server and, optionally, at least one third party server, wherein the components are suitable for performing the method in accordance with claim 1.

15. A proxy server or Flash socket server suitable for performing a method in accordance with claim 1.

16. A method in accordance with claim 2, wherein an authentication procedure is initiated before the establishing of the Flash socket connection by the client device, in particular the Flash player, to check the authorization of a Flash socket connection between the client device and the Flash socket server.

17. A method in accordance with claim 16, wherein the third party server corresponds to an information server, for example a web server, from which the client device has retrieved or would like to retrieve information in a user-controlled manner.

18. A method in accordance with claim 3, wherein the third party server corresponds to an information server, for example a web server, from which the client device has retrieved or would like to retrieve information in a user-controlled manner.

19. A method in accordance with claim 2, wherein the third party server corresponds to an information server, for example a web server, from which the client device has retrieved or would like to retrieve information in a user-controlled manner.

20. A method in accordance with claim 17, wherein the Flash socket server checks on an incoming request of a client device whether the requested advertising content and/or advertising media are already available on the third party server and only initiates a transmission if they are not yet available.
